(19) United States
(12) Patent Application Publication
(10) Pub. No.: US 2026/0141575 A1
(43) Pub. Date: May 21, 2026

(54) TECHNIQUES FOR AUTOMATING BUILDING MATERIAL AUDITS BASED ON IMAGERY AND BUILDING METADATA

(71) Applicant: AUTODESK, INC., San Francisco, CA (US)

(72) Inventors: Nikita KLIMENKO, Cambridge, MA (US); James STODDART, Atlanta, GA (US); Lorenzo VILLAGGI, Brooklyn, NY (US); Arianna RAMPINI, Ciampino (IT); Adam James GAIER, Bonn (DE); Dale ZHAO, New York, NY (US); John Henry LOCKE, New York, NY (US); David BENJAMIN, Brooklyn, NY (US)

(21) Appl. No.: 19/319,205

(22) Filed: Sep. 4, 2025

Related U.S. Application Data
(60) Provisional application No. 63/722,519, filed on Nov. 19, 2024.

(51) Int. Cl. G06T 11/00; G06V 10/77; G06V 10/82; G06V 20/10

(52) U.S. Cl. CPC G06T 11/00; G06V 10/7715; G06V 10/82; G06V 20/176

(57) ABSTRACT

In various embodiments, a computer-implemented method for determining compositions of buildings includes receiving a plurality of building images associated with a building, generating a conditional image based on the plurality of building images, generating a plurality of tokens characterizing the building, providing the conditional image and the plurality of tokens to a neural network to cause the neural network to generate an output, generating, via a generative artificial intelligence (AI) model, a structural floorplan of the building based on the output and the plurality of tokens, and determining a composition of the building based on the structural floorplan.

### CROSS-REFERENCE TO RELATED APPLICATION

This application claims the priority benefit of U.S. Provisional Patent Application No. 63/722,519, entitled “TECHNIQUES FOR UTILIZING GENERATIVE AI AND MULTIMODAL DATA TO AUTOMATE BUILDING MATERIAL AUDITS,” filed Nov. 19, 2024, the contents of which are incorporated by reference herein in its entirety.

### BACKGROUND

### Field of the Various Embodiments

Embodiments of the present disclosure relate generally to computer science, artificial intelligence, and complex software applications and, more specifically, to techniques for automating building material audits based on imagery and building metadata.

### Description of the Related Art

The construction industry is responsible for a large portion of global carbon dioxide emissions. A significant portion of such emissions stems from operational emissions associated with running and maintaining buildings. However, another significant portion of such emissions stems from the construction of new buildings, such as emissions associated with building materials such as cement, steel, and aluminum. Additionally, other construction-related activities generate further emissions, such as emissions related to fuel, electricity, and other construction-related activities. As a result, due to sustainability advantages, renovation and remodeling of existing structures constitute an increasing portion of construction-related activity as opposed to building new structures. Reusing or recycling a building or such materials is an approach that is increasingly utilized for sustainability purposes. In general, assessment of the composition of a building in terms of the building structure and the construction materials used in the building's structural plan is important. A building material audit is an assessment of the materials used in a building or construction project that involves identifying, cataloging, and evaluating the materials used in a building or a project.

One drawback of reuse or recycling of buildings is the need to perform building material audits. Reuse of buildings and the materials therein is often made difficult by the complexity of such audits. A building material audit often can require expensive, invasive, and sometimes destructive tests, site visits, or other procedures. In some cases, detailed information about a building is often missing, particularly in the case of older structures. For example, to ascertain the materials used in a structural plan, walls or other structural elements may need to be scanned, removed, or damaged. Accordingly, a building material audit represents an expensive and time-consuming process that can burden the process of reusing or recycling a building or the materials therein.

As the foregoing illustrates, what is needed in the art are more effective techniques for performing building material audits.

### SUMMARY

In various embodiments, a computer-implemented method for determining compositions of buildings includes receiving a plurality of building images associated with a building, generating a conditional image based on the plurality of building images, generating a plurality of tokens characterizing the building, providing the conditional image and the plurality of tokens to a neural network to cause the neural network to generate an output, generating, via a generative artificial intelligence (AI) model, a structural floorplan of the building based on the output and the plurality of tokens, and determining a composition of the building based on the structural floorplan.

At least one technical advantage of the disclosed techniques relative to the prior art is that the disclosed techniques enable building material audits to be performed using generative artificial intelligence (AI) models, such as a diffusion model. The generative AI model is trained to generate a structural plan of a building based on one or more images of the building along with building metadata from various information sources. The building materials used in the structural plan of the building can be deduced from the structural plan shown by the model. Therefore, a building material audit can be automated and performed in a non-destructive and non-invasive manner. The disclosed techniques also offer building designers data about material reuse that streamline existing building design.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of the various embodiments.

FIG. 2 is an illustration of the model trainer of FIG. 1, according to various embodiments.

FIG. 3 is a more detailed illustration of how the building audit application of FIG. 1 generates a structural floorplan of a building design from which the material composition of the building is determined, according to various embodiments.

FIG. 4 is a flow diagram of method steps for training a generative AI model, according to various embodiments.

FIG. 5 is a flow diagram of method steps for determining a material composition of a building, according to various embodiments.

FIG. 6 is a more detailed illustration of a computing device that can implement the functionalities of the entities illustrated in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

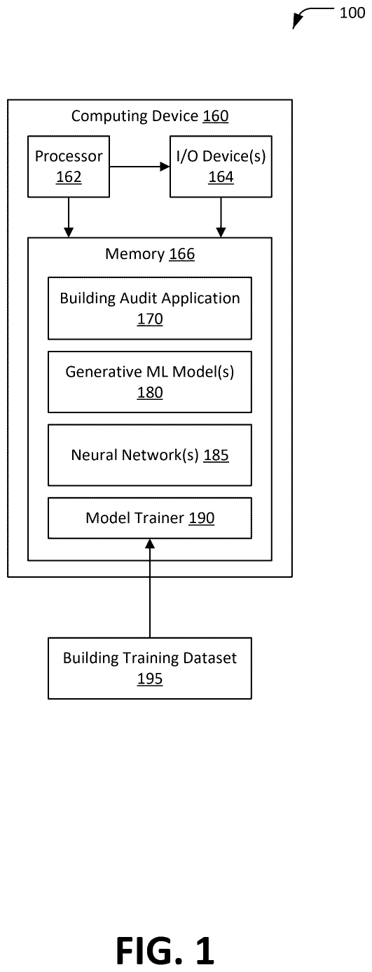

FIG. 1 is a conceptual illustration of a system 100 configured to implement one or more aspects of the various embodiments. As shown, in some embodiments, the system 100 includes, without limitation, a computing device 160. The computing device 160 includes, without limitation, a processor 162, one or more I/O devices 164, and a memory 166. The memory 166 includes, without limitation, a building audit application 170, one or more generative AI models 180, a neural network 185, and a model trainer 190. In some other embodiments, the system 100 can include or access any number and/or types of other client devices, server devices, remotely located ML models, or any combination thereof.

Any number of the components of the system 100 can be distributed across multiple geographic locations or implemented in one or more cloud computing environments (e.g., encapsulated shared resources, software, data) in any combination. In some embodiments, the computing device 160 and/or zero or more other server devices (not shown) can be implemented as one or more compute instances in a cloud computing environment, implemented as part of any other distributed computing environment, or implemented in a stand-alone fashion. In various embodiments, the computing device 160 can be integrated with any number and/or types of other devices (e.g., one or more other compute instances and/or a display device) into a user device. Some examples of user devices include, without limitation, desktop computers, laptops, smartphones, and tablets.

Computing device 160 includes a processor 162, I/O devices 164, and a memory 166, coupled together. Processor 162 includes any technically feasible set of hardware units configured to process data and execute software applications, such as one or more CPUs. I/O devices 164 include any technically feasible set of devices configured to perform input and/or output operations, such as, for example and without limitation, a display device, a keyboard, and/or a touchscreen, among others.

Memory 166 includes any technically feasible storage media configured to store data and software applications, such as, for example and without limitation, a hard disk, a RAM module, and/or a ROM. Memory 166 includes a building audit application 170, generative AI models 180, neural network 185, and a model trainer 190. Generative AI models 180 include one or more diffusion models trained on vast amounts of data to receive and respond to multi-modal prompts. In one embodiment, generative AI models 180 may be configured to interact with one or more application programming interface (API) endpoints in order to transmit prompts and receive responses from other diffusion models located on one or more remote servers. As a general matter, building audit application 170, one or more generative AI models 180, neural network 185, and model trainer 190 can represent separate portions of a distributed software entity that is configured to perform any and all of the various operations described herein.

Building audit application 170 receives images and certain building metadata associated with a building and generates a structural floorplan of the building. From the structural floorplan, the material composition of the building is determined or approximated. For example, building audit application 170 receives one or more elevational images, or side images, of a building. In one embodiment, the elevational images are obtained from mapping services or can be captured by a user of the building audit application 170 and provided as an input. Building audit application 170 can also receive one or more overhead images of a building. The overhead images of the building can be obtained from satellites, aircraft or other image sources. The building audit application 170 can also receive a building footprint mask image of the building. The building footprint mask represents an overhead outline of the building footprint, often without any structures or building mechanical structures shown that are frequently on the roof or other parts of the exterior of the building. In some embodiments, the building footprint mask image is also referred to as a building outline. In some embodiments, building audit application 170 receives a building window layout image, which includes one or more images that indicate the windows of the building. The building window layout image can include overhead images, elevational images, or other views that indicate the location of one or more windows of the building. In one example, the building window layout image is an overhead image that indicates where in the building footprint the building windows are located from the overhead view of the building.

Building audit application 170 also can also receive one or more textual descriptions or textual building metadata that characterizes the building. For example, the textual building metadata can include a number of floors of the building, the primary construction material, or the age of the building or year of construction. The building metadata can further include a building class or quality, such as whether the building is considered class A, class B, or class C construction.

Based on the images and building metadata, the building audit application 170 generates a building structural floorplan using generative AI models 180 and neural network 185. The building structural floorplan represents an estimated or approximated structural floorplan of the building based on data about the building that is observable without having to perform any invasive or destructive actions to the building. From the building structural floorplan, the material composition of the building can be estimated or approximated. For example, the number of steel beams can be counted in a generated building structural floorplan. The total area corresponding to bearing walls can be used to calculate a total amount of concrete or brick use per floor of the building. The location of circulation core elements in a building structural floorplan can indicate areas of the building that are challenging or expensive to modify. When combined with the information on the number of floors of a building, these calculations can extend to the total quantity of beams, columns, slabs, walls, or foundation elements in a building. In other words, the amount of steel, concrete, or other materials used in the building can be determined based on the structural floorplan and the number of floors in the building. As another example, the material composition of the building is determined based on the quantity of beams, columns, slabs, walls, or foundation elements in the structural floorplan.

The generative AI models 180 include one or more generative AI models that have been trained on a relatively large amount of existing data, such as a building training dataset 195. The building training dataset 195 includes a set of building elevational images, a corresponding set of building overhead images, corresponding building metadata, and training floorplans. The training floorplans can specify the structural floorplan and/or a floorplan layout of one or more floors of the buildings represented in building training dataset 195. In various embodiments, a remotely executed generative AI model can be utilized that communicates with the computing device 160 to receive prompts and generate a building floorplan based on provided inputs from building audit application 170. In some embodiments, generative AI model 180 represents a diffusion model that can generate one or more image outputs based on provided inputs. In some embodiments, the generative AI model 180 can include a generative adversarial network (GAN), such as DCGAN or StyleGAN, or other models that can receive a random noise vector and/or condition inputs to generate an image output. Generative AI model 180 can also include a variational autoencoder or diffusion models. Examples of diffusion models include stable diffusion, DALL-E2, Imagen, or other models that receive a text input and generate image outputs. In various embodiments, the generative AI model 180 can be trained to generate a structural floorplan based on tokens that are provided as inputs to the generative AI model 180. In one implementation, building audit application 170 generates one or more tokens based on building images and provides the tokens to the generative AI model 180.

Neural network 185 is a neural network that acts as an auxiliary module to guide the creation of a building floorplan using generative AI model 180. In one embodiment, generative AI model 180 and neural network 185 operate in tandem to generate a building floorplan based on building image data and building metadata. In one implementation, neural network 185 generates a conditional image that operates as a conditional input into the generative AI model 180 to guide the creation of the building floorplan. In one implementation, neural network 185 is implemented in a ControlNet architecture alongside a generative AI model 180 that is implemented as a diffusion model. Neural network 185 injects conditioning information into the image generation process performed by generative AI model 180, which ultimately generates the building structural floorplan. In one embodiment, neural network 185 receives as inputs from building audit application 170 the building elevational images, overhead images, building footprint mask images, and building window layout images. Based on the provided images, neural network 185 generates a conditional image that is provided as a conditioning input into the generative AI model 180 to guide the creation of the building structural floorplan. In one embodiment, neural network 185 outputs feature maps that represent the features of the input images that are learned by the neural network 185. The feature maps are provided as an input to generative AI model 180 by the neural network 185. Building audit application 170 also provides the one or more tokens to the generative AI model 180 as inputs. In some examples, the building audit application 170 further provides one or more prompts instructing the generative AI model 180 to generate a building structural plan as an output based on the provided inputs.

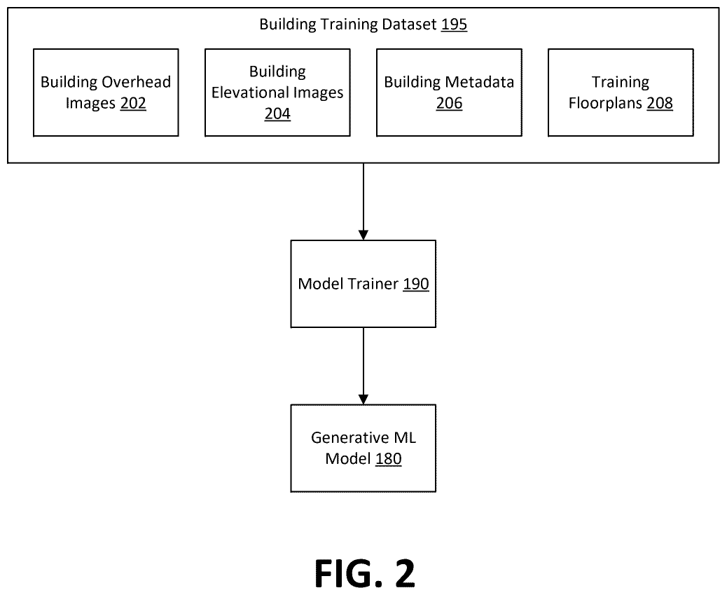

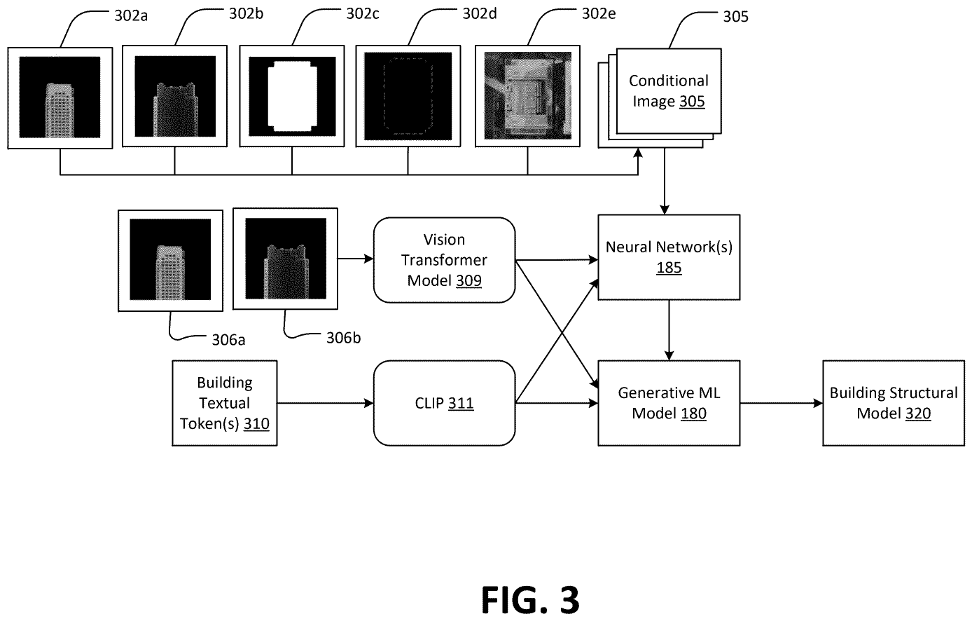

Model trainer 190 trains the generative AI model 180 based on a building training dataset 195. As noted above, the building training dataset 195 includes a set of building elevational images, a corresponding set of building overhead images, corresponding building metadata, and training floorplans. The training floorplans can specify the structural floorplan and/or a floorplan layout of one or more floors of the buildings represented in building training dataset 195. The techniques for training the generative AI model 180 and for generating a building structural floorplan are described in more detail in the discussion of FIGS. 2-3.

### Model Training

FIG. 2 is a more detailed illustration of the model trainer 190 of FIG. 1, according to various embodiments. As shown, model trainer 190 receives or accesses building training dataset 195, which can include various types of data about buildings. For example, building training dataset 195 can include building overhead images 202, which are overhead images of buildings. Building overhead images 202 can be obtained from commercial mapping or imagery sources, from satellite or aircraft imagery, or other sources of overhead imagery that show the building from overhead. Building training dataset 195 can also include building elevational images 204. Building elevational images 204, or side view images, represent images of the building from one or more sides. Similarly to building overhead images 202, building elevational images 204 can be obtained from commercial mapping or imagery sources or from any other source of building imagery. Building metadata 206 represents text-based information about the building. Building metadata 206 includes a number of floors, construction materials, building age, building size, building renovation data, information about building elevator shafts or elevator banks, construction techniques, or any other building metadata that describes or characterizes the building. Building metadata 206 can be obtained from commercial or residential listing services, tax records, or other sources of building metadata describing the building. Training floorplans 208 represent structural floorplans or floor layouts associated with buildings in the building training dataset 195. Training floorplans 208 along with the other information in building training dataset 195, can be used to train generative AI model 180 to generate a building structural floorplan.

Upon receiving a building training dataset 195, model trainer 190 trains generative AI model 180 to generate a building structural floorplan based on tokens representing building images and building metadata. Generative AI model 180 can generate a building structural floorplan as an output. As noted above, the generative AI model 180 and neural network 185 can be configured alongside each other, with the neural network 185 providing a conditional image and operating as a conditional input that guides the creation of a building structural floorplan. The configuration of generative AI model 180 and neural network 185 to generate a building structural floorplan is further discussed in connection with FIG. 3 below.

### Generating a Building Structural Floorplan

FIG. 3 provides a more detailed illustration of how the building audit application 170 of FIG. 1 generates a structural floorplan of a building design, from which the material composition of the building is determined, according to various embodiments. FIG. 3 illustrates how the building audit application 170 can facilitate the generation of a building structural model 320, from which the composition of a building can be determined. As shown, the building audit application 170 receives one or more building images 302 as an input. The building images 302 correspond to a building for which the building audit application 170 is generating a building structural model 320, so that the material composition of the building can be determined from the building structural model 320.

In the example of FIG. 3, the building images 302 include a side image 302a, side image 302b, a building footprint mask image 302c, a building window layout image 302d, and an overhead image 302e. In some scenarios, more or fewer building images 302 can be provided as inputs to building audit application 170.

Building images 306 are also provided as an input to building audit application 170. Building images 306 can include a subset of building images 302, or be the same as building images 302. Building audit application 170 utilizes a vision transformer model 309 to generate one or more tokens, which can be textual tokens, based on the building images 306. The vision transformer model 309 can include a model such as ViT, DeiT, Swin, DINO, DINOv2, or other types of models that can perform image classification operations to generate tokens characterizing input images.

Building audit application 170 also receives building textual tokens 310 as inputs. Building textual tokens 310 are extracted from building metadata and characterize the building for which building audit application 170 is performing a building audit and/or generating a building structural model 320. For example, building textual tokens 310 can include the number of floors of a building, a building class, a primary construction material, and the age of the building. The textual tokens 310 can be provided to a contrastive language-image pretraining model 311 as input, which outputs one or more tokens that are provided to generative AI model 180. In some embodiments, contrastive language-image pretraining model 311 receives one or more of the building images 306 as input alongside the textual tokens 310. Additionally, in some embodiments, contrastive language-image pretraining model 311 outputs an image embedding representing the visual content of the building images 306, a text embedding representing the semantic meaning of the textual tokens 310, and a score indicating the similarity of the images and text. The outputs of the contrastive language-image pretraining model 311 are provided to generative AI model 180 and used to generate building structural model 320.

From the provided building images 302, and the tokens output by vision transformer model 309 and contrastive language-image pretraining model 311, building audit application 170 generates a conditional image 305. The conditional image 305 can include edge maps, depth maps, segmentation maps, or other types of conditional image types or features. In various embodiments, building audit application 170 generates the conditional image 305 using an edge map technique, a pose estimation that generates a pose skeleton image, by generating a depth map, by generating a semantic segmentation map, or by using any other technique that creates a conditional image 305 based on the building images 302. Conditional image 305 is provided as an input to neural network 185, which generates an output that is provided to generative AI model 180. The output of neural network 185 represents a conditioning input that is provided to generative AI model 180 to guide the creation of building structural model 320 by generative AI model 180, such as a diffusion model utilized by building audit application 170 to generate an output image corresponding to building structural model 320.

Accordingly, generative AI model 180 receives the output of neural network 185 and one or more tokens based on building images 306 and textual tokens 310 that are provided as inputs to building audit application 170. The output of neural network 185 comprises one or more feature maps that represent the features of the input images learned by the neural network 185 based upon the conditional image 305. Based on the training of generative AI model 180 by model trainer 190, generative AI model 180 outputs a building structural model 320 based on the tokens from vision transformer model 309, contrastive language-image pretraining model 311, and the output of neural network 185.

In some embodiments, building audit application 170 determines the material composition of the building represented by building images 302, building images 306, and/or textual tokens 310, based on the building structural model 320. The material composition is included in, or serves as the basis of, a building audit.

### Model Training

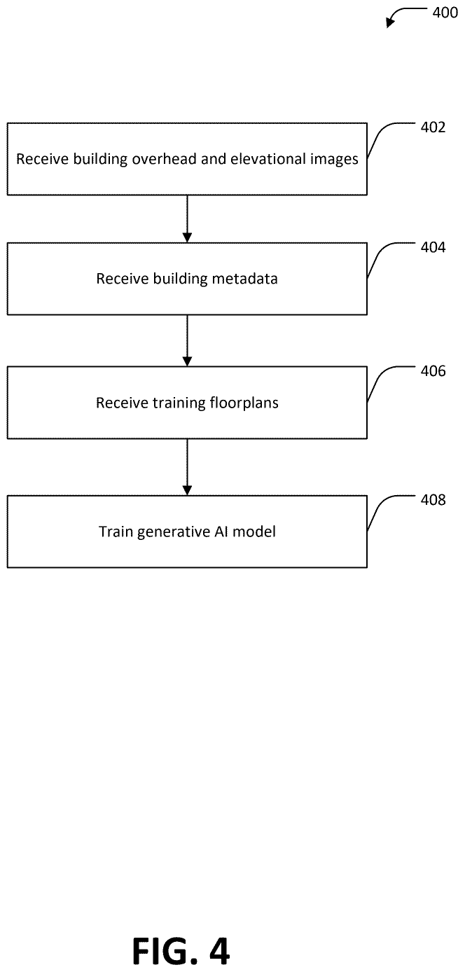

FIG. 4 is a flow diagram of method steps for training generative AI model 180 based on building training dataset 195, according to various embodiments. Although the method steps are described in conjunction with the systems of FIGS. 1-3, persons skilled in the art will understand that any system configured to perform the method steps, in any order, is within the scope of the present invention.

As shown, a method 400 begins at step 402, where model trainer 190 receives building overhead images 202, elevational images 204, and any other images associated with a building. In some examples, model trainer 190 can receive additional types of images of a building or fewer types of images of a building. The building overhead images 202 and elevational images 204 can be captured by satellite, aircraft, or other mechanisms.

At step 404, model trainer 190 receives building metadata 206. Building metadata 206 represents text-based information about the building. Building metadata 206 includes a number of floors, construction materials, building age, building size, building renovation data, information about building elevator shafts or elevator banks, construction techniques, or any other building metadata that describes or characterizes the building. Building metadata 206 can be obtained from commercial or residential listing services, tax records, or other sources of building metadata describing the building.

At step 406, model trainer 190 receives training floorplans 208. Training floorplans 208 represent structural floorplans or floor layouts associated with buildings in the building training dataset 195. Training floorplans 208, along with other information in building training dataset 195, can be used to train generative AI model 180 to generate a building structural floorplan. It should be appreciated that model trainer 190 can also receive other types of building training dataset 195 used to train generative AI model 180 to generate a building structural model 320 based on image and text inputs. Accordingly, at step 408, model trainer 190 initiates training of one or more generative AI model 180 based on the building training dataset 195.

### Generating Building Structural Floorplans

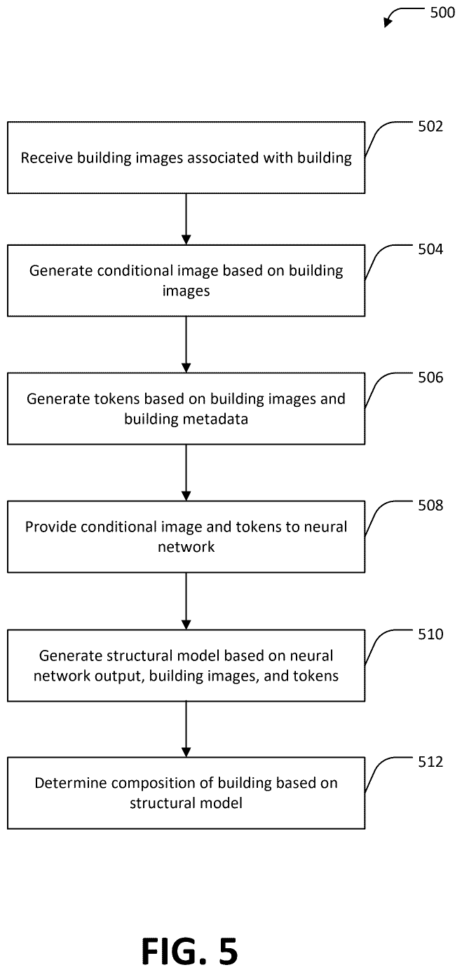

FIG. 5 is a flow diagram of method steps for generating a building structural floorplan and determining a composition of the building based on the building structural floorplan, according to various embodiments. Although the method steps are described in conjunction with the systems of FIGS. 1-3, persons skilled in the art will understand that any system configured to perform the method steps, in any order, is within the scope of the present invention.

As shown, a method 500 begins at step 502, where the building audit application 170 receives building images 302 associated with a building. The building images 302 can include one or more side images of the building, a building footprint mask image, a building window layout image, and one or more overhead images of the building. At step 504, the building audit application 170 generates a conditional image 305 based on the provided building images 302. As noted above, the conditional image 305 is provided to a neural network 185, which generates a conditioning input to guide the creation of the building structural model 320 by a generative AI model 180.

At step 506, the building audit application 170 generates one or more tokens based on one or more building images 306, such as side images of the building. The one or more tokens can also be generated based on textual tokens 310 characterizing the building that are based on building metadata. The one or more tokens can be respectively generated by a vision transformer model 309 that receives the building images 306 as an input and by a contrastive language-image pretraining model 311 that receives the textual tokens 310 and, in some cases, the building images 306 as inputs. The one or more tokens are provided as an input to the generative AI model 180 and the neural network 185. At step 508, the building audit application 170 provides the tokens generated by the vision transformer model 309 and the contrastive language-image pretraining model 311 to the neural network 185. Additionally, the conditional image 305 generated based on building images 302 is also provided as an input to the neural network 185. The neural network 185 injects conditioning information into the image generation process performed by the generative AI model 180, which ultimately generates the building structural floorplan. As noted above, the building images 302 as an input, and based on the provided images, generates a conditional image that is provided as a conditioning input into the generative AI model 180 to guide the creation of the building structural floorplan. In some embodiments, the neural network 185 outputs feature maps that represent the features of the input images that are learned by the neural network 185. The feature maps are provided as an input to the generative AI model 180 by the neural network 185.

At step 510, the building audit application 170 generates a building structural model 320 of the building using the generative AI model 180. The generative AI model 180 generates the building structural model 320 based on the output from the neural network 185 and the output of the vision transformer model 309 and the contrastive language-image pretraining model 311. In some embodiments, the output from the neural network 185 comprises a feature map that is generated based on the building images 302. The output of the vision transformer model 309 comprises one or more tokens generated based on building images 306. The output of the vision transformer model 309 comprises one or more tokens generated based on the textual tokens 310 generated from building metadata.

At step 512, the building audit application 170 determines the material composition of the building based on the building structural model 320 generated by the generative AI model 180. From the building structural floorplan, the material composition of the building can be estimated or approximated. For example, the amount of steel, concrete, or other materials used in the building can be determined based on the structural floorplan and the number of floors in the building. Based on the material composition of the building determined from the building structural model 320, the building audit application 170 automates one or more steps within a building audit conducted for the building.

### System Implementation

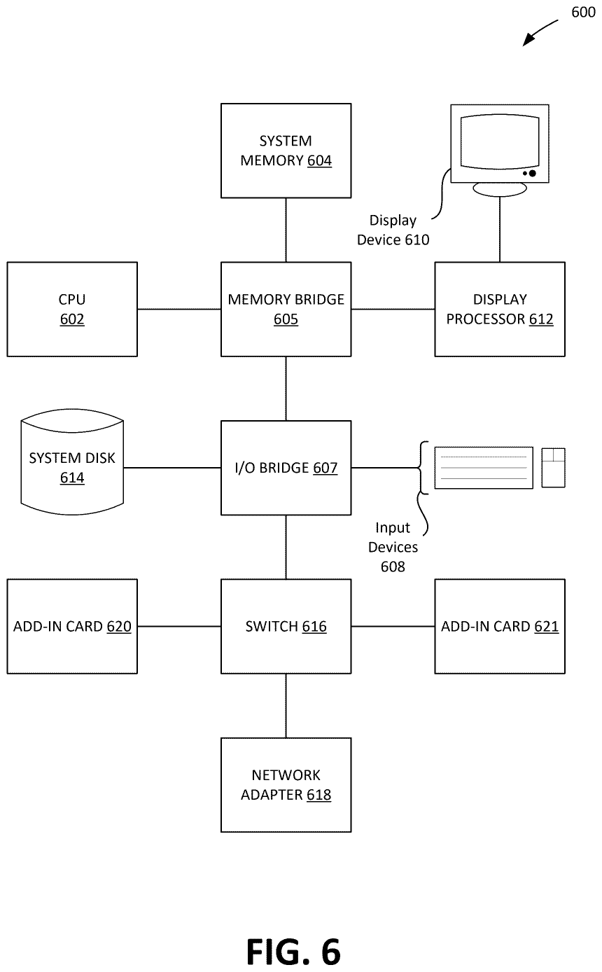

FIG. 6 is a more detailed illustration of a computing device that can implement the functionalities of the entities illustrated in FIG. 1, according to various embodiments. The computing device can represent computing device 160 and any other computing devices discussed throughout the disclosure (such as server devices with which the computing device 160 is communicably coupled. This figure in no way limits or is intended to limit the scope of the various embodiments. In various implementations, system 600 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 600 may be coupled together to practice one or more aspects of the various embodiments.

As shown, system 600 includes a central processing unit (CPU) 602 and a system memory 604 communicating via a bus path that may include a memory bridge 605. CPU 602 includes one or more processing cores, and, in operation, CPU 602 is the master processor of system 600, controlling and coordinating operations of other system components. System memory 604 stores software applications and data for use by CPU 602. CPU 602 runs software applications and optionally an operating system. Memory bridge 605, which may be, e.g., a Northbridge chip, is connected via a bus or other communication path (e.g., a HyperTransport link) to an I/O (input/output) bridge 607. I/O bridge 607, which may be, e.g., a Southbridge chip, receives user input from one or more user input devices 608 (e.g., keyboard, mouse, joystick, digitizer tablets, touch pads, touch screens, still or video cameras, motion sensors, and/or microphones) and forwards the input to CPU 602 via memory bridge 605.

A display processor 612 is coupled to memory bridge 605 via a bus or other communication path (e.g., a PCI Express, Accelerated Graphics Port, or HyperTransport link); in one embodiment display processor 612 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 604.

Display processor 612 periodically delivers pixels to a display device 610 (e.g., a screen or conventional CRT, plasma, OLED, SED or LCD based monitor or television). Additionally, display processor 612 may output pixels to film recorders adapted to reproduce computer generated images on photographic film. Display processor 612 can provide display device 610 with an analog or digital signal. In various embodiments, one or more of the various graphical user interfaces set forth in FIG. 3 are displayed to one or more users via display device 610, and the one or more users can input data into and receive visual output from those various graphical user interfaces.

A system disk 614 is also connected to I/O bridge 607 and may be configured to store content and applications and data for use by CPU 602 and display processor 612. System disk 614 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 616 provides connections between I/O bridge 607 and other components such as a network adapter 618 and various add-in cards 620 and 621. Network adapter 618 allows system 600 to communicate with other systems via an electronic communications network, and may include wired or wireless communication over local area networks and wide area networks such as the Internet.

Other components (not shown), including USB or other port connections, film recording devices, and the like, may also be connected to I/O bridge 607. For example, an audio processor may be used to generate analog or digital audio output from instructions and/or data provided by CPU 602, system memory 604, or system disk 614. Communication paths interconnecting the various components in FIG. 6 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 612 incorporates circuitry optimized for graphics and video processing, including, for example, video output circuitry, and constitutes a graphics processing unit (GPU). In another embodiment, display processor 612 incorporates circuitry optimized for general purpose processing. In yet another embodiment, display processor 612 may be integrated with one or more other system elements, such as the memory bridge 605, CPU 602, and I/O bridge 607 to form a system on chip (SoC). In still further embodiments, display processor 612 is omitted and software executed by CPU 602 performs the functions of display processor 612.

Pixel data can be provided to display processor 612 directly from CPU 602. In some embodiments, instructions and/or data representing a scene are provided to a render farm or a set of server computers, each similar to system 600, via network adapter 618 or system disk 614. The render farm generates one or more rendered images of the scene using the provided instructions and/or data. These rendered images may be stored on computer-readable media in a digital format and optionally returned to system 600 for display. Similarly, stereo image pairs processed by display processor 612 may be output to other systems for display, stored in system disk 614, or stored on computer-readable media in a digital format.

Alternatively, CPU 602 provides display processor 612 with data and/or instructions defining the desired output images, from which display processor 612 generates the pixel data of one or more output images, including characterizing and/or adjusting the offset between stereo image pairs. The data and/or instructions defining the desired output images can be stored in system memory 604 or graphics memory within display processor 612. In an embodiment, display processor 612 includes 3D rendering capabilities for generating pixel data for output images from instructions and data defining the geometry, lighting shading, texturing, motion, and/or camera parameters for a scene. Display processor 612 can further include one or more programmable execution units capable of executing shader programs, tone mapping programs, and the like.

Further, in other embodiments, CPU 602 or display processor 612 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 602, display processor 612, or one or more other processing devices or any combination of these different processors.

CPU 602, render farm, and/or display processor 612 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 600 may be a robot or robotic device and may include CPU 602 and/or other processing units or devices and system memory 604. In such embodiments, system 600 may or may not include other elements shown in FIG. 6. System memory 604 and/or other memory units or devices in system 600 may include instructions that, when executed, cause the robot or robotic device represented by system 600 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 604 is connected to CPU 602 directly rather than through a bridge, and other devices communicate with system memory 604 via memory bridge 605 and CPU 602. In other alternative topologies display processor 612 is connected to I/O bridge 607 or directly to CPU 602, rather than to memory bridge 605. In still other embodiments, I/O bridge 607 and memory bridge 605 might be integrated into a single chip. The particular components shown herein are optional; for instance, any number of add-in cards or peripheral devices might be supported. In some embodiments, switch 616 is eliminated, and network adapter 618 and add-in cards 620, 621 connect directly to I/O bridge 607.

In sum, the disclosed techniques include training a machine learning model to generate a building structural plan based on images and textual metadata about a building. By generating the building structural plan, the material composition of the building or the structure of the building can be determined without using invasive or destructive building audit techniques. A generative AI model is used alongside a neural network to generate the building structural plan. A ControlNet architecture is utilized to guide the creation of the building structural floorplan based on the image and text inputs.

At least one technical advantage of the disclosed techniques relative to the prior art is that the disclosed techniques enable building material audits to be performed using generative artificial intelligence (AI) models, such as a diffusion model. The generative AI model is trained to generate a structural plan of a building based on one or more images of the building along with building metadata from various information sources. The building materials used in the structural plan of the building can be deduced from the structural plan shown by the model. Therefore, a building material audit can be automated and performed in a non-destructive and non-invasive manner. The disclosed techniques also offer building designers data about material reuse that streamline existing building design.
1. In some embodiments, a computer-implemented method for determining compositions of buildings comprises receiving a plurality of building images associated with a building, generating a conditional image based on the plurality of building images, generating a plurality of tokens characterizing the building, providing the conditional image and the plurality of tokens to a neural network to cause the neural network to generate an output, generating, via a generative artificial intelligence (AI) model, a structural floorplan of the building based on the output and the plurality of tokens, and determining a composition of the building based on the structural floorplan.
2. The computer-implemented method of clause 1, wherein determining the composition of the building is based on a quantity of beams, columns, slabs, walls, or foundation elements in the structural floorplan.
3. The computer-implemented method of clauses 1 or 2, wherein the output of the neural network comprises at least one feature map representing features of the building based on the plurality of building images.
4. The computer-implemented method of any of clauses 1-3, wherein the output of the neural network is provided as a conditioning input to the generative AI model to provide structural guidance for generating the structural floorplan.
5. The computer-implemented method of any of clauses 1-4, wherein the plurality of tokens comprise textual tokens describing one or more features of the building.
6. The computer-implemented method of any of clauses 1-5, wherein the plurality of tokens are generated based on the plurality of building images.
7. The computer-implemented method of any of clauses 1-6, wherein at least a subset of the plurality of tokens are generated using a vision transformer model that receives at least a subset of the plurality of building images and outputs the at least a subset of the plurality of tokens.
8. The computer-implemented method of any of clauses 1-7, wherein at least a subset of the plurality of tokens are generated based on building metadata describing one or more aspects of the building.
9. The computer-implemented method of any of clauses 1-8, wherein the at least a subset of the plurality of tokens are generated using a contrastive language-image pretraining process based on the building metadata.
10. The computer-implemented method of any of clauses 1-9, further comprising providing a textual prompt to the generative AI model, wherein the textual prompt instructs the generative AI model to generate the structural floorplan based on the output of the neural network and the plurality of tokens.
11. The computer-implemented method of any of clauses 1-10, wherein the plurality of building images comprises at least one of an elevational image of the building, an overhead image of the building, a building footprint mask image, or a building window layout image.
12. In some embodiments, one or more non-transitory computer-readable media include instructions that, when executed by one or more processors, cause the one or more processors to determine compositions of buildings, by performing the steps of receiving a plurality of building images associated with a building, generating a conditional image based on the plurality of building images, generating a plurality of tokens characterizing the building, providing the conditional image and the plurality of tokens to a neural network to cause the neural network to generate an output, generating, via a generative artificial intelligence (AI) model, a structural floorplan of the building based on the output and the plurality of tokens, and determining a composition of the building based on the structural floorplan.
13. The one or more non-transitory computer-readable media of clause 12, wherein the steps further comprise training the generative AI model to generate the structural floorplan based on a plurality of training floorplans.
14. The one or more non-transitory computer-readable media of clauses 12 or 13, wherein the steps further comprise training the generative AI model to generate structural floorplans based on at least one of elevational images of a plurality of buildings or overhead images of the plurality of buildings.
15. The one or more non-transitory computer-readable media of any of clauses 12-14, wherein the steps further comprise training the generative AI model to generate structural floorplans based on building metadata specifying a respective composition of a plurality of buildings in a training data set.
16. The one or more non-transitory computer-readable media of any of clauses 12-15, wherein the determining the composition of the building is based on a quantity of beams, columns, slabs, walls, or foundation elements in the structural floorplan.
17. The one or more non-transitory computer-readable media of any of clauses 12-16, wherein the output of the neural network comprises at least one feature map representing features of the building based on the plurality of building images.
18. The one or more non-transitory computer-readable media of any of clauses 12-17, wherein the output of the neural network comprises at least one feature map representing features of the building based on the plurality of building images.
19. The one or more non-transitory computer-readable media of any of clauses 12-18, wherein the plurality of tokens comprise textual tokens describing one or more features of the building or are generated based on the plurality of building images.
20. In some embodiments, a system comprises one or more memories storing instructions, and one or more processors coupled to the one or more memories that, when executed, determine compositions of buildings, by performing the steps of receiving a plurality of building images associated with a building, generating a conditional image based on the plurality of building images, generating a plurality of tokens characterizing the building, providing the conditional image and the plurality of tokens to a neural network to cause the neural network to generate an output, generating, via a generative artificial intelligence (AI) model, a structural floorplan of the building based on the output and the plurality of tokens, and determining a composition of the building based on the structural floorplan.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for determining compositions of buildings, the method comprising:
receiving a plurality of building images associated with a building;
generating a conditional image based on the plurality of building images;
generating a plurality of tokens characterizing the building;
providing the conditional image and the plurality of tokens to a neural network to cause the neural network to generate an output;
generating, via a generative artificial intelligence (AI) model, a structural floorplan of the building based on the output and the plurality of tokens; and
determining a composition of the building based on the structural floorplan.

2. The computer-implemented method of claim 1, wherein determining the composition of the building is based on a quantity of beams, columns, slabs, walls, or foundation elements in the structural floorplan.

3. The computer-implemented method of claim 1, wherein the output of the neural network comprises at least one feature map representing features of the building based on the plurality of building images.

4. The computer-implemented method of claim 1, wherein the output of the neural network is provided as a conditioning input to the generative AI model to provide structural guidance for generating the structural floorplan.

5. The computer-implemented method of claim 1, wherein the plurality of tokens comprise textual tokens describing one or more features of the building.

6. The computer-implemented method of claim 1, wherein the plurality of tokens are generated based on the plurality of building images.

7. The computer-implemented method of claim 6, wherein at least a subset of the plurality of tokens are generated using a vision transformer model that receives at least a subset of the plurality of building images and outputs the at least a subset of the plurality of tokens.

8. The computer-implemented method of claim 5, wherein at least a subset of the plurality of tokens are generated based on building metadata describing one or more aspects of the building.

9. The computer-implemented method of claim 8, wherein the at least a subset of the plurality of tokens are generated using a contrastive language-image pretraining process based on the building metadata.

10. The computer-implemented method of claim 1, further comprising providing a textual prompt to the generative AI model, wherein the textual prompt instructs the generative AI model to generate the structural floorplan based on the output of the neural network and the plurality of tokens.

11. The computer-implemented method of claim 1, wherein the plurality of building images comprises at least one of an elevational image of the building, an overhead image of the building, a building footprint mask image, or a building window layout image.

12. One or more non-transitory computer-readable media including instructions that, when executed by one or more processors, cause the one or more processors to determine compositions of buildings, by performing the steps of:
receiving a plurality of building images associated with a building;
generating a conditional image based on the plurality of building images;
generating a plurality of tokens characterizing the building;
providing the conditional image and the plurality of tokens to a neural network to cause the neural network to generate an output;
generating, via a generative artificial intelligence (AI) model, a structural floorplan of the building based on the output and the plurality of tokens; and
determining a composition of the building based on the structural floorplan.

13. The one or more non-transitory computer-readable media of claim 12, wherein the steps further comprise training the generative AI model to generate the structural floorplan based on a plurality of training floorplans.

14. The one or more non-transitory computer-readable media of claim 12, wherein the steps further comprise training the generative AI model to generate structural floorplans based on at least one of elevational images of a plurality of buildings or overhead images of the plurality of buildings.

15. The one or more non-transitory computer-readable media of claim 12, wherein the steps further comprise training the generative AI model to generate structural floorplans based on building metadata specifying a respective composition of a plurality of buildings in a training data set.

16. The one or more non-transitory computer-readable media of claim 12, wherein the determining the composition of the building is based on a quantity of beams, columns, slabs, walls, or foundation elements in the structural floorplan.

17. The one or more non-transitory computer-readable media of claim 12, wherein the output of the neural network comprises at least one feature map representing features of the building based on the plurality of building images.

18. The one or more non-transitory computer-readable media of claim 12, wherein the output of the neural network comprises at least one feature map representing features of the building based on the plurality of building images.

19. The one or more non-transitory computer-readable media of claim 12, wherein the plurality of tokens comprise textual tokens describing one or more features of the building or are generated based on the plurality of building images.

20. A system, comprising:
one or more memories storing instructions; and
one or more processors coupled to the one or more memories that, when executed, determine compositions of buildings, by performing the steps of:
receiving a plurality of building images associated with a building;
generating a conditional image based on the plurality of building images;
generating a plurality of tokens characterizing the building;
providing the conditional image and the plurality of tokens to a neural network to cause the neural network to generate an output;
generating, via a generative artificial intelligence (AI) model, a structural floorplan of the building based on the output and the plurality of tokens; and
determining a composition of the building based on the structural floorplan.
